(19) United States
(12) Patent Application Publication
(10) Pub. No.: US 2016/0180677 A1
(43) Pub. Date: Jun. 23, 2016

(54) APPARATUS FOR REDUCING DRIVER DISTRACTION VIA SHORT RANGE VEHICLE COMMUNICATION

(71) Applicant: Ford Global Technologies, LLC, Dearborn, MI (US)

(72) Inventors: Eric L. REED, Livonia, MI (US); Thomas Lee MILLER, Ann Arbor, MI (US)

(21) Appl. No.: 14/575,330

(22) Filed: Dec. 18, 2014

(51) Int. Cl. G08B 21/02; H04W 4/00; H04W 4/04; H04W 4/12

(52) U.S. Cl. CPC G08B 21/02; H04W 4/12; H04W 4/005; H04W 4/046

(57) ABSTRACT

In at least one embodiment, an apparatus is provided that includes a vehicle controller. The vehicle controller is programmed to receive a signal indicative of an eye gaze of a driver and to transmit an advertisement to a personal communication device (PCD) to indicate that the driver is distracted in response to the eye gaze of the driver being diverted off of a road for a period of time that exceeds an associated time threshold.

### TECHNICAL FIELD

Aspects disclosed herein generally relate to an apparatus for reducing driver distraction via short range vehicle communication.

### BACKGROUND

Distracted driving due to manual interaction with a cellular phone is a growing societal issue. There is an effort to curb the use of cell phones while driving. The National Highway Traffic Safety Administration (NHTSA) has issued guidelines for automotive infotainment systems in an effort to minimize distractions. An example of this is set forth in “Visual-Manual NHTSA Driver Distraction Guidelines for In-Vehicle Device” by the National Traffic Safety Administration. Docket No. NHTSA-2010-0053, Feb. 16, 2012. Within these guidelines, NHTSA is proposing a requirement for cell phones to implement a method to lock out certain tasks while driving. At the international level, the International Telecommunications Union (ITU) initiated a working group to identify any actions that can be taken to address distracted driving.

There are currently several apps available to consumers that will restrict cell phone usage while driving. These apps often require hardware to be installed on the vehicle. Others require the phone to monitor its own speed via global positioning satellite (GPS) information and automatically shut down the phone while traveling at significant speeds. These apps may be popular but not useful due to the voluntary nature of these apps and the inability to discern between a driver and passenger.

### SUMMARY

In at least one embodiment, an apparatus is provided that includes a vehicle controller. The vehicle controller is programmed to receive a signal indicative of an eye gaze of a driver and to transmit an advertisement to a personal communication device (PCD) to indicate that the driver is distracted in response to the eye gaze of the driver being diverted off of a road for a period of time that exceeds an associated time threshold.

In at least another embodiment, an apparatus is provided that includes a personal communication device (PCD). The PCD is programmed to receive a first advertisement from a vehicle indicative of a driver being in a distracted state and to initiate a timer in response to the first advertisement. The PCD is further programmed to receive a second advertisement from the vehicle also indicative of the driver being in the distracted state and to restrict an operation of the PCD in response to the second advertisement being received prior to an expiration of the timer.

In at least another embodiment, a method is provided that includes receiving, at a vehicle controller, a signal indicative of an eye gaze of a driver and determining whether the eye gaze of the driver has been diverted off of a road for a period of time that exceeds an associated time threshold. The method further includes transmitting an advertisement to a personal communication device (PCD) to indicate that the driver is distracted in the event the period of time exceeds the associated time threshold

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 depicts an apparatus for reducing driver distraction via short range vehicle communication in accordance to one embodiment;

FIG. 2 depicts a method that is executed at a vehicle for reducing driver distraction via short range vehicle communication in accordance to one embodiment; and

FIG. 3 depicts a method that is executed at a personal communication device for reducing driver distraction via short range vehicle communication in accordance to one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Embodiments of the present disclosure generally provide for a plurality of circuits or other electrical devices. All references to the circuits and other electrical devices, and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof, and software which co-act with one another to perform operation(s) disclosed herein.

Various embodiments as provided herein are facilitated by the wireless transmission of advertisement signals from a vehicle to a cellphone via Bluetooth® Low Energy (BLE) or other suitable transmission protocol. One example of an implementation that utilized BLE to facilitate communication between the vehicle and a cell phone is set forth in the pending provisional application U.S. Ser. No. 61/923,989 filed on Jan. 6, 2014 entitled “APPARATUS AND METHOD FOR IN-VEHICLE LOCATION OF A MOBILE DEVICE” which is hereby incorporated by reference in its entirety. The foregoing application generally discloses an apparatus and method that utilizes a received signal strength from a known transmitter in the vehicle. In addition, an infotainment system in the vehicle may be used to collaborate with cell phones to determine a location for such phones. The embodiments disclosed herein provide, inter alia, an in-vehicle driver gaze implementation that is capable of communicating, via the vehicle, with a cell phone to determine whether a driver is distracted and to further restrict operations of the cell phone in the event the driver is distracted. Such restrictions or restricted operations may include, but not limited to, forcing hands free operation, restricting the usage of dialing on the cell phone, looking through an address book on the cell phone, preventing in-coming calls, requiring an in-coming call to go through speakers in the vehicle if the cell phone receiving the in-coming call is electrically paired to a vehicle controller, etc.

In general, the BLE implementation does not require that the vehicle and the cellphone undergo a pairing operation for such devices to communicate with one another. With BLE, a transmitting device (e.g., the vehicle) may be designated as an advertiser and the receiving device (e.g., the cell phone) may be designated as a scanner. Thus, the advertiser transmits a signal referred to an as advertisement (or an advertisement signal) to the scanner. The advertisement signal may include generic information such as, but not limited to, an identification of the transmitter (i.e., the vehicle), name, manufacturer specific data (e.g., weight, location, etc.). The scanner will scan or look for the advertisements from the advertiser. Depending on the implementation, the scanner may ignore the advertisement or process the data on the advertisement for various functions. Additionally, the advertiser may service a scan request from the scanner to provide any desired additional information. As noted above, one advantage of the advertiser/scanner relationship in the BLE implementation is that neither device has to be electronically paired and connected to authorize communication between such devices. In general, the BLE implementation enables the vehicle and the cell phone to utilize reduced power consumption and cost while maintaining a similar communication range to that of Bluetooth®.

Advancements in camera technology and image processing have enabled various systems to track a person's eye gaze. Such systems may be used in vehicles to determine if a driver is actively watching and engaged with the road ahead or if the driver has instead become distracted. The systems may be used to provide a warning to a driver to pay attention to the road. It is recognized herein that the advertiser/scanner implementation in connection with BLE may be utilized with an automotive eye gaze system to assist in curtailing driver distractions associated with the use of various personal communication devices (PCDs) such as but not limited to cell phones while driving. The eye gaze implementation may be situated to determine when the driver is distracted for a period time that is greater than a predetermined time threshold. If this condition is met, then the vehicle may then transmit an advertisement to the PCD indicating that the driver is in a distracted state. The PCD may then disable any number of operations while the driver is driving in the distracted state to prevent the driver from using the PCD while driving. Any number of features can be disabled on the PCD such as buttons/switches for data entry for texting, searching contact, internet, etc.

It is recognized that in the event the driver is distracted, the vehicle may provide the advertisement indicating this condition to all of the PCDs in the vehicle (e.g., drivers and passengers). In this case, while it is not desirable to limit the operation of the PCD belonging to the passenger(s), this condition may cause the passenger(s) to influence the driver to stop using the PCD in a manner that causes the driver to be distracted. As long as the driver of the vehicle remains focused on the driving task, PCDs belonging to the passengers experience full operation.

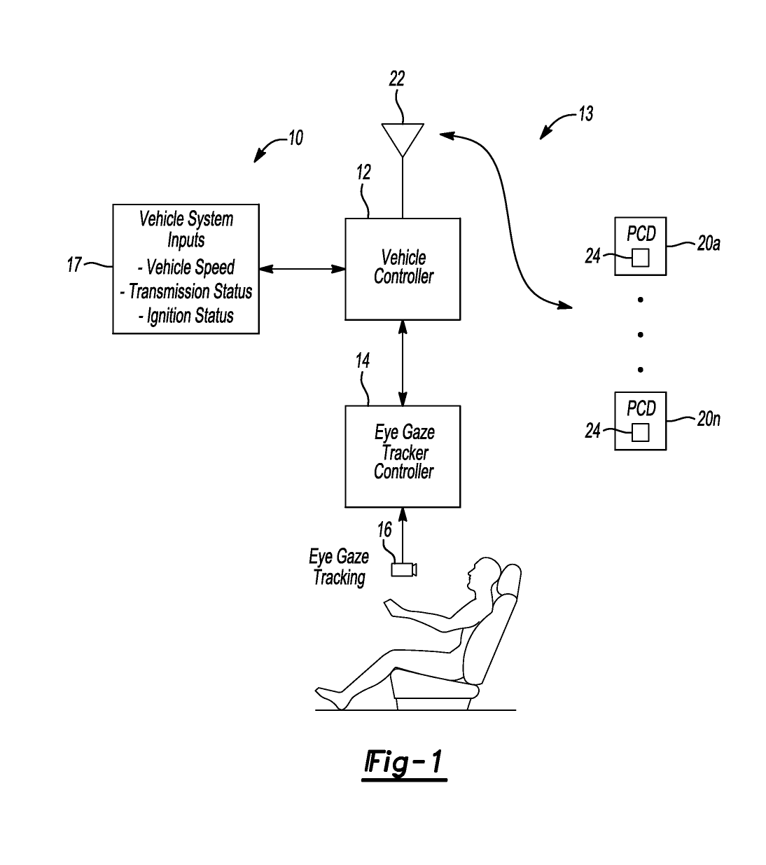

FIG. 1 depicts an apparatus 10 for reducing driver distraction in a vehicle 13 via short range vehicle communication in accordance to one embodiment. The apparatus 10 generally includes a vehicle controller 12, an eye gaze controller 14, and an eye gaze camera 16. It is recognized that the vehicle controller 12 and the eye gaze controller 14 may be implemented in a single controller, or alternatively be implemented as separate stand-alone controllers as shown in FIG. 1. The eye gaze camera 16 may be fixed or orientated toward a head of a driver 18 in the vehicle 13. Any number of PCDs 20a-20n (“20”) may be positioned in the vehicle 13. Such PCDs 20a-20n may be a cell phone or other suitable device.

The vehicle controller 12 is generally part of an in-vehicle communication system and includes at least one transmitter (not shown) and at least one receiver (not shown) which interfaces with the at least one of the PCDs 20 (e.g., a PCD 20 belonging to the driver 18) to enable voice input control to perform a function with the PCD 20 so that the driver does not have to enter data directly into the PCD 20. The vehicle controller 12 may interface with switches (not shown) positioned within the vehicle 13 and to enable touch selection control to perform a function with the PCD 20 so that the driver does not have to enter data directly into the PCD 20. In one example, the vehicle controller 12 may be implemented as part of the SYNC system developed by Ford Motor Company® and Microsoft®. Switches may be positioned on the vehicle controller 12, a steering wheel (not shown) on the vehicle 13, etc.

It is further recognized that the vehicle controller 12 includes a transceiver 22 for enabling communication with any one or more of the various PCDs 20 in the vehicle 13 via BLE. Thus, in this regard, the vehicle controller 12 may serve as the advertiser and transmit, via short range communication, an advertisement message (or signal) that indicates a driver distracted state to the PCDs 20 (e.g., the PCDs 20 serve as scanners) in the vehicle 13. This condition allows the vehicle 13 to communicate with all of the PCDs 20 in the vehicle 13 as opposed to just the driver's PCD 20 when the vehicle 13 communicates via the SYNC system as noted above. The vehicle controller 12 may receive a plurality of vehicle system inputs 17 over a data communication bus 26. The data communication bus 26 may be implemented as a High/Medium Speed Controller Area Network (CAN) bus, a Local Interconnect Network (LIN) bus or other suitable bus generally situated to facilitate data transfer there through. The particular type of bus used may be varied to meet the desired criteria of a particular implementation.

Such vehicle system inputs 17 may comprise a vehicle speed message, a transmission status message, and an ignition status message. The vehicle speed message provides information indicative of the speed of the vehicle 13. An engine controller (not shown) or other suitable controller provides the vehicle speed message to the vehicle controller 12. The transmission status message provides information indicative of whether the vehicle transmission is in a PARK (P), Reverse (R), Neutral (N), Drive (D), or Low (L) state. A transmission controller (not shown) may transmit the transmission status message to the vehicle controller 12. The ignition status message provides information indicative of whether the vehicle 13 is on OFF, RUN, or START position. A body controller (not shown) may transmit the ignition status message to the vehicle controller 12. The relevance of such vehicle system inputs 17 will be discussed in more detail below.

As noted above, the eye gaze camera 16 may be fixed or orientated toward the head of the driver 18. Therefore, eye gaze camera 16 may capture images corresponding to moments in which the driver 18 has diverted his/her eyes from off of the road from which the vehicle 13 is traveling. For example, the driver 18 in this case may be using the PCD 20 such as by utilizing buttons/switches on the PCD 20 to input data, etc. which may cause his/her eyes to divert from the road. The eye gaze camera 16 transmits such captured images to the eye gaze controller 14 for processing. In response to the eye gaze controller 14 processing such captured images and determining that the driver has diverted his/her eyes off of the road for a period of time that exceeds a time based threshold, the eye gaze controller 14 may then send a control signal to the vehicle controller 12 to indicate that the driver is in a distracted state. In the event the vehicle controller 12 determines that the vehicle is moving (e.g., based on the one or more of the vehicle system inputs 17 such as the vehicle speed message (or vehicle speed signal) indicating that a speed of the vehicle exceeds a speed threshold (e.g., 0, 3, 5 kph, etc.) or the transmission status message (or transmission status signal) indicating that the vehicle is in a non-PARK mode), then the vehicle controller 12 may advertise, or transmit the advertisement message to all of the PCDs 20 in the vehicle 13 to indicate that the driver 18 is in the distracted state.

The one or more PCDs 20 in the vehicle 13, even those belonging to passengers, may disable any and all operations related to the manual entry of data into the PCD 20 (e.g., texting, internet use via manual data entry, search for contact information, etc.). As noted above, all of the PCDs 20 in the vehicle 13 may have features or operations disabled in addition to the PCD 20 belonging to the driver 18. In this manner, the passengers may then persuade or apply pressure to the driver 18 to cease manually inputting information into the PCD 20 and to regain focus to the road ahead. Thus, once the driver 18 is detected to divert his/her eyes back on the road based on the images captured and processed by the eye gaze system (e.g., the eye gaze camera 16 and the eye gaze controller 14), the vehicle controller 12 receives another control signal indicating that the driver is no longer distracted and wirelessly transmits another advertisement to the PCDs 20 to allow the passengers the ability to fully utilize their respective PCDs.

As noted above, since the PCDs 20 are may not be paired to the vehicle controller 12 and the vehicle controller 12 is generally configured to wirelessly transmit the advertisement to any of the PCDs 20 within the short range distance, the various PCDs 20 themselves may each determine whether the vehicle 13 is moving. For example, each PCD 20 includes a Global Positioning Satellite (GPS) circuit 24 (or 24a-24n for multiple PCDs 20 as illustrated in FIG. 1) therein to provide the information corresponding to the velocity and location of the PCD 20. In general, as the PCD 20 moves along with the vehicle 13, its corresponding GPS circuit 24 provides the position of the PCD 20 (or the vehicle 13 assuming the PCD 20 is in the vehicle 13) and the velocity of the PCD 20 as the PCD 20 move across a surface of the earth in the vehicle 13. The GPS circuit 24 provides coordinate data such as the longitude and the latitude of the PCD 20 to provide the location of the PCD 20. In general, a plurality of satellites (not shown) communicates with the GPS circuit 24 of the PCD 20. The GPS circuit 24 establishes the vehicle's position and velocity relative to the earth's position and surface by processing data received from the satellites. Thus, in this regard, each PCD 20 can determine whether the vehicle is moving by virtue of the PCD 20 moving with the vehicle 13. Therefore, once the PCD 20 receives the advertisement from the vehicle controller 12 that indicates that the driver is in a distracted state, the PCD 20 may determine if the vehicle 13 is moving and employ restrictions thereof if after the PCD 20 determines that this condition is true. In this case, the vehicle controller 12 does not have to necessarily determine whether the vehicle 13 is moving based on vehicle speed or transmission status and may simply transmit the advertisement to the PCD 20 in the event the driver is distracted (e.g., as determined via the eye gaze controller 14) and the PCD 20 can simply monitor whether the vehicle 13 is moving and employ restrictions if the vehicle 13 is moving and if the advertisement indicates that the driver is distracted. This condition enables any of the PCDs 20 in the vehicle 13 to simply receive the advertisements via the BLE without the need for the vehicle controller 12 and the corresponding PCDs 20a-20n to have to undergo a separate or additional step of pairing or handshaking to enable communication with the vehicle controller 12. Thus, each PCD 20 may be responsible for determining whether it is necessary to employ restrictions. The vehicle 13 in this case transmits the advertisements indicating the distracted or non-distracted state to the PCDs 20 and the corresponding PCDs 20 determine when to initiate the restrictions. The types of restrictions imposed by the PCDs 20 may vary based on the manufacturer of the PCDs.

It is recognized that the vehicle 13 may be traveling alongside, or other neighboring vehicles that are either parked or moving. In this case, it is possible for the vehicle controller 12 in the vehicle 13 to transmit the advertisement to other PCDs located in the neighboring vehicle. Thus, to account for these transient conditions, each PCD includes a timer that is initiated once the first advertisement is received at each corresponding PCD located outside of the vehicle 13. In this regard, the PCD will monitor for receipt of a second advertisement within a predetermined time frame or prior to the expiration of the timer. If the second advertisement is not received while the timer is running at the PCD in the neighboring vehicle, then the PCD will not employ any restrictions. In general, each PCD 20 will initiate or trigger the timer after the receipt of each advertisement. If a subsequent advertisement is not received upon expiration of the corresponding timer, then the PCD 20 will no longer employ restrictions. If only a single advertisement indicating that the driver is distracted is received while the timer is running, then the PCD will not impose any restrictions and this condition may generally correspond to a transient condition. Alternatively, this condition may also correspond to the driver simply leaving the vehicle. It is recognized that the PCD 20 can be arranged to employ restrictions after receiving only a single advertisement. This condition may be set forth by the manufacturer of the PCD.

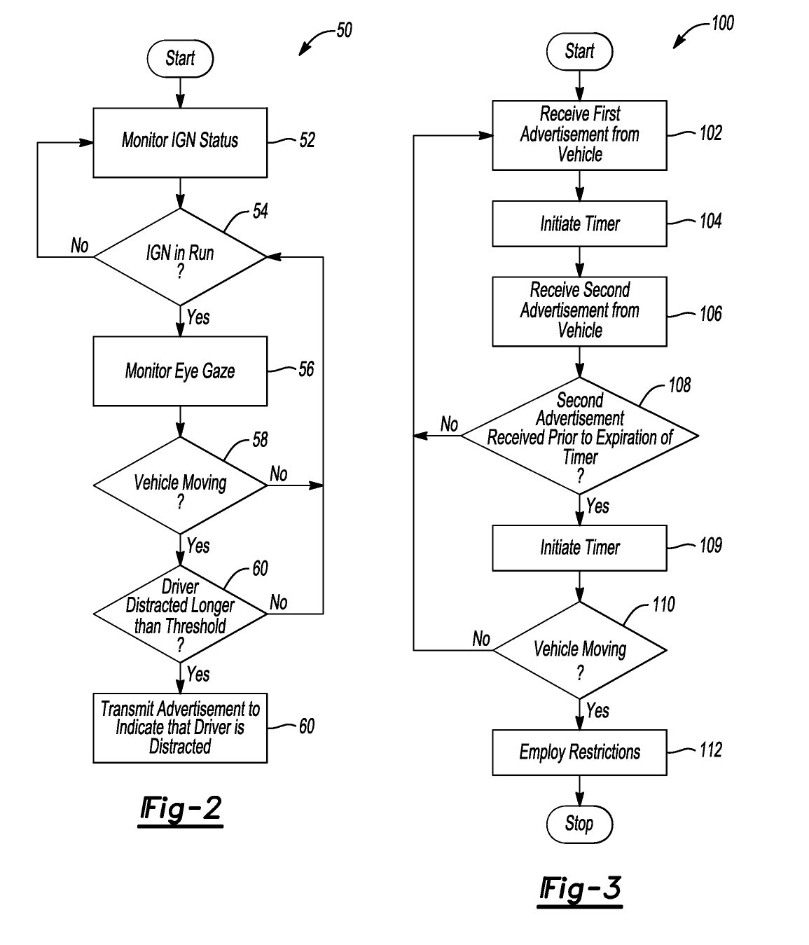

FIG. 2 depicts a method 50 that is executed at the vehicle 13 for reducing driver distraction via short range vehicle communication in accordance to one embodiment.

In operation 52, the vehicle controller 12 receives the ignition status message.

In operation 54, the vehicle controller 12 determines whether the ignition is in RUN. If this condition is true, then the method 50 proceeds to operation 56. If not, the method 50 proceeds back to operation 52.

In operation 56, the vehicle controller 12 receives a signal from the eye gaze controller 14 that indicates the eye gaze of the driver, or whether the driver is holding his/her PCD 20 to a corresponding ear, or in front of them.

In operation 58, the vehicle controller 12 determines whether the vehicle 13 is moving based on either the vehicle speed signal or the transmission status signal.

In operation 60, the vehicle controller 12 determines whether the driver has diverted his/her eyes off of the road for an amount of time that exceeds a threshold. In addition, the vehicle controller 12 may also determine whether the driver is holding his/her PCD 20 to a corresponding ear, or in front of them for a time period that exceeds the threshold. If this condition is true, then the driver is determined to be distracted and the method 50 proceeds to operation 62. If not, the method 50 proceeds back to operation 54.

In operation 62, the vehicle controller 12 transmits the advertisement as a BLE signal to the PCD(s) 20 indicating that the driver in the vehicle 13 is distracted.

FIG. 3 depicts a method 100 that is executed at the PCD 20 for reducing driver distraction via short range vehicle communication in accordance to one embodiment.

In operation 102, the PCD 20 receives a first advertisement via a BLE signal from the vehicle 13. The first advertisement may indicate that the driver is distracted.

In operation 104, the PCD 20 initiates a timer in response to receiving the advertisement.

In operation 106, the PCD 20 receives a second advertisement indicating that the driver is distracted.

In operation 108, the PCD 20 determines whether the second advertisement has been received while the timer is running or before the timer has expired. If this condition is true, then the method 100 moves to operation 109. If not, then the method 100 moves back to operation 102.

In operation 109, the PCD 20 re-initiates the timer in response to determining that the second advertisement from the vehicle 13 has been received prior to the expiration of the timer.

In operation 110, the PCD 20 determines whether the vehicle 13 is moving. As noted above, the GPS circuit 24 determines whether the PCD 20 is moving by monitoring the velocity and/or recognizing a change in latitudinal and/or longitudinal coordinates. The PCD 20 may be moving by virtue of it being positioned in the vehicle 13 and as the vehicle 13 moves, the GPS coordinates will change and/or a velocity of the vehicle 13 will be detected. If this condition is true, then the method 100 moves to operation 112. If not, then the method 102 moves back to operation 102.

It is recognized that the PCD 20 may not have to utilize the GPS circuit 24 to determine if the vehicle 13 is moving. For example, as discussed above, the vehicle controller 12 is generally arranged to transmit the advertisement to indicate that the driver is distracted when the vehicle 13 itself determines that it is moving. However, various manufacturers of the PCDs 20 may utilize the GPS circuit 24 to determine if the vehicle 13 is moving or alternatively, such manufacturers may configure the PCD 20 to bypass utilizing the GPS circuit 24 to minimize power consumption of the PCD 20 and automatically determine that the vehicle 13 is moving in response to receiving to operation 108 being a true condition. As noted above, operation 108 is employed to remove transient conditions such as when the vehicle 13 passes by a neighboring vehicle (i.e., that is either parked or moving) that includes the PCD 20 and that may receive the advertisement(s) from the vehicle controller 12 in the vehicle 13. If a second or subsequent advertisement is not received while the timer is running, this condition indicates that the PCD 20 in the neighboring vehicle is not intended to receive the advertisement from the vehicle 13 and the single advertisement can thus be ignored.

In operation 112, the PCD 20 employs the restrictions as noted above.

It is further recognized that the vehicle 13 does not necessarily have to depend on the eye gaze of the driver to determine whether the driver of the vehicle 13 is distracted. Other mechanisms may be used in the vehicle 13 to determine whether the driver is distracted such as by monitoring a lane departure while the vehicle 13 is being driven. For example, the vehicle controller 12 may detect a shift in the driver's performance that may cause the vehicle 13 to leave a lane or head off of the road as disclosed in U.S. Pat. No. 8,775,020 to Miller et al. which is hereby incorporated by reference in its entirety. In this case, the driver's performance may be negatively affected because the driver is using the cell phone (or PCD 20) which may cause the vehicle 13 to drift off of the lane. Once the drift is detected and a corresponding Driver Impairment Monitor (DIMON) rating is characterized by the vehicle controller 12, the vehicle controller 12 may then transmit advertisement(s) to the PCD 20.

Likewise, acoustic metrics may be detected with respect to the driver as set forth in U.S. Publication No. 2014/0231166 to Miller et al. which is hereby incorporated by reference in its entirety. In the event the speech performance of the driver indicates that the driver is distracted or impaired, the vehicle 13 may transmit the advertisement to the PCD 20 so that restrictions are employed at the PCD 20. In general, any mechanism may be used at the vehicle 13 to determine whether the driver is distracted or impaired. Once this condition is established at the vehicle 13, the vehicle controller 12 may then transmit the advertisement in order to employ the restrictions as set forth in FIG. 3.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An apparatus comprising:
a vehicle controller programmed to:
receive a signal indicative of an eye gaze of a driver; and
transmit an advertisement to a personal communication device (PCD) to indicate that the driver is distracted in response to the eye gaze of the driver being diverted off of a road for a period of time that exceeds an associated time threshold.

2. The apparatus of claim 1 wherein the vehicle controller is further programmed to receive a vehicle speed signal indicative of a speed of the vehicle.

3. The apparatus of claim 2 wherein the vehicle controller is further programmed to determine whether the speed of the vehicle exceeds a speed threshold prior to transmitting the advertisement to the PCD.

4. The apparatus of claim 3 wherein the vehicle controller is further programmed to transmit the advertisement to the PCD in response to the speed of the vehicle being greater than the speed threshold.

5. The apparatus of claim 1 wherein the vehicle controller is further programmed to receive a transmission status signal indicative of whether the vehicle is in a non-PARK mode.

6. The apparatus of claim 5 wherein the vehicle controller is further programmed to transmit the advertisement to the PCD in response to the vehicle being in the non-PARK mode.

7. The apparatus of claim 1 further comprising a transmitter that is arranged to transmit, via Bluetooth low energy, the advertisement to the PCD.

8. An apparatus comprising:
a personal communication device (PCD) programmed to:
receive a first advertisement from a vehicle indicative of a driver being in a distracted state;
initiate a timer in response to the first advertisement;
receive a second advertisement from the vehicle also indicative of the driver being in the distracted state; and
restrict an operation of the PCD in response to the second advertisement being received prior to an expiration of the timer.

9. The apparatus of claim 8 wherein the PCD is further programmed to re-initiate the timer in response to the second advertisement.

10. The apparatus of claim 8 wherein the PCD includes a global positioning satellite (GPS) circuit programmed to determine whether the PCD is moving by measuring a change in velocity of the PCD prior to restricting the operation.

11. The apparatus of claim 10 wherein the PCD is further programmed to restrict the operation in response to determining that the PCD is moving.

12. The apparatus of claim 10 wherein the first advertisement and the second advertisement are also indicative of the vehicle being in a moving state.

13. The apparatus of claim 8 wherein the PCD is further programmed to inhibit restricting the operation thereof in the event the first advertisement is received and the second advertisement is not received.

14. The apparatus of claim 8 wherein the PCD is further programmed to receive the first advertisement and the second advertisement via Bluetooth low energy from the vehicle.

15. The apparatus of claim 8 wherein the PCD is further programmed to restrict operation thereof by at least one of preventing dialing operations performed thereon, preventing in-coming calls, and requiring in-coming calls to be routed to vehicle speakers.

16. A method comprising:
receiving, at a vehicle controller, a signal indicative of an eye gaze of a driver;
determining whether the eye gaze of the driver has been diverted off of a road for a period of time that exceeds an associated time threshold; and
transmitting an advertisement to a personal communication device (PCD) to indicate that the driver is distracted in the event the period of time exceeds the associated time threshold.

17. The method of claim 16 further comprising receiving a vehicle speed signal indicative of a speed of the vehicle prior to transmitting the advertisement to the PCD.

18. The method of claim 17 further comprising determining whether the speed of the vehicle exceeds a speed threshold prior to transmitting the advertisement to the PCD.

19. The method of claim 18 further comprising transmitting the advertisement to the PCD in response to the speed of the vehicle being greater than the speed threshold.

20. The method of claim 16 further comprising transmitting, via Bluetooth low energy, the advertisement to the PCD.
